(19) United States
(12) Patent Application Publication
(10) Pub. No.: US 2011/0158258 A1
(43) Pub. Date: Jun. 30, 2011

(54) Communication signal processing apparatus and communication apparatus

(75) Inventors: Satoshi Suzuki, Nagoya (JP); Tomohisa Kishigami, Obu-shi (JP)

(73) Assignee: DENSO CORPORATION, Kariya-city (JP)

(21) Appl. No.: 12/928,928

(22) Filed: Dec. 22, 2010

(30) Foreign Application Priority Data
Dec. 24, 2009 (JP) 2009-292494

(51) Int. Cl. H04J 3/24

(52) U.S. Cl. 370/475

(57) ABSTRACT

A communication signal processing apparatus includes: a transmitted-signal processing unit which, in accordance with a transmitted signal outputted from a communication control apparatus, transmits a communication signal indicating “dominant” via the communication line by applying a current to a communication line, and transmits a communication signal indicating “recessive” via the communication line by not applying a current to the communication line; and a received-signal processing unit which determines whether the communication signal received via the communication line indicates “dominant” or “recessive”, then outputs a received signal indicating the determination result to the communication control apparatus. The received-signal processing unit outputs a signal indicating “recessive” to the communication control apparatus as the received signal, regardless of the communication signal received via the communication line, during a signal-keeping period of time from the time when detecting a change from “dominant” to “recessive” based on the communication signal received via the communication line.

### CROSS REFERENCE TO RELATED APPLICATION

This application is based on and claims the benefit of priority from earlier Japanese Patent Application No. 2009-292494 filed Dec. 24, 2009, the description of which is incorporated herein by reference.

### BACKGROUND OF THE INVENTION

1. Technical Field of the Invention

The present invention relates to a communication signal processing apparatus and a communication apparatus including the communication signal processing apparatus.

2. Related Art

Conventionally, a communication system is known in which a plurality of communication apparatuses transmit/receive communication signals to/from each other via a common communication line. In this type of communication system, a communication line, which is a main line, has a plurality of branch lines, to each of which a communication apparatus is connected. According to such a network configuration, a reflected wave can be generated due to a characteristic impedance mismatch at a branch point (connecting point between the branch line and the main line) at which the branch line branches off from the main line. The generation of such a reflected wave creates distortion of waveforms of the communication signal, causing false determination of the received communication signal in the communication apparatus.

To solve the above problem, JP-A-H07-202947 discloses a configuration in which a resistor is inserted in a branch line for impedance matching at a branch point. In addition, JP-A-2006-237763 discloses a configuration in which the characteristic impedance of a cable used as a branch line is changed. According to such configurations, the amplitude of a normal communication signal is also suppressed. Thus, the number of branch lines must be limited for normal communication.

In addition, JP-A-2006-101430 discloses a configuration in which a diode and a Zener diode are arranged in parallel so that the direction from a negative output terminal to a positive output terminal of a communication apparatus is the forward direction.

According to the configuration disclosed in JP-A-2006-101430, reflected waves of the negative electrode side can be suppressed by the forward voltage of the diode, and reflected waves of the positive electrode side having voltage equal to or more than the Zener voltage can be suppressed. However, a Zener diode having Zener voltage more than the voltage of communication signals has to be used to prevent normal communication signals from being suppressed by the Zener diode. Thus, a reflected wave whose voltage level is equivalent to that of a normal communication signal is allowed at the positive electrode side, and the reflected wave can be incorrectly interpreted as a normal communication signal.

### SUMMARY

An embodiment provides a communication signal processing apparatus and a communication apparatus which can prevent a communication signal from being incorrectly interpreted due to a reflected wave.

As an aspect of the embodiment, the communication signal processing apparatus, which is included in one of a plurality of communication apparatuses configuring a communication system in which the communication apparatuses transmit/receive a communication signal to/from each other via a common communication line, and which functions as an interface between the communication line and a communication control apparatus which is included in the communication apparatus and performs a process for controlling communication, includes: a transmitted signal processing unit which, in accordance with a transmitted signal outputted from the communication control apparatus, transmits a communication signal indicating “dominant” via the communication line by applying a current to the communication line, and transmits a communication signal indicating “recessive” via the communication line by not applying a current to the communication line; and a received signal processing unit which determines whether the communication signal received via the communication line indicates “dominant” or the communication signal indicates “recessive”, then outputs a received signal indicating the determination result to the communication control apparatus. The received signal processing unit outputs a signal indicating “recessive” to the communication control apparatus as the received signal, regardless of the communication signal received via the communication line, during a predetermined signal-keeping period of time from the time when detecting a change from “dominant” to “recessive” based on the communication signal received via the communication line.

### BRIEF DESCRIPTION OF THE DRAWINGS

In the accompanying drawings:

FIG. 1 is a block diagram schematically showing the configuration of the communication system according to a first embodiment;

FIG. 2 is a circuit diagram of an ECU according to the first embodiment;

FIG. 3 is a circuit diagram of a transmitter according to the first embodiment;

FIG. 4 is a diagram showing waveforms concerning an operation of the transmitter according to the first embodiment;

FIG. 5 is a circuit diagram of a receiver according to the first embodiment;

FIG. 6 is a circuit diagram of a constant pulse width detection circuit;

FIG. 7 is a diagram showing waveforms concerning an operation of the constant pulse width detection circuit;

FIG. 8 is a diagram showing waveforms concerning an operation of the receiver according to the first embodiment;

FIG. 9 is a circuit diagram of a receiver according to a second embodiment;

FIG. 10 is a diagram showing waveforms concerning an operation of the receiver according to the second embodiment;

FIG. 11 is a circuit diagram of an ECU according to a third embodiment;

FIG. 12 is a circuit diagram of a transmitter according to the third embodiment;

FIG. 13 is a circuit diagram of a receiver according to the third embodiment; and

FIG. 14 is a diagram showing waveforms concerning operations of the transmitter and the receiver according to the third embodiment.

### DETAILED DESCRIPTION OF THE PREFERRED EMBODIMENTS

Hereinafter, embodiments will be described with reference to the accompanying drawings. In the embodiments set forth below, the components identical with or similar to each other are given the same reference numerals for the sake of omitting explanation.

### 1. First Embodiment

First, a communication system according to the first embodiment will be described.

(1-1. General Configuration)

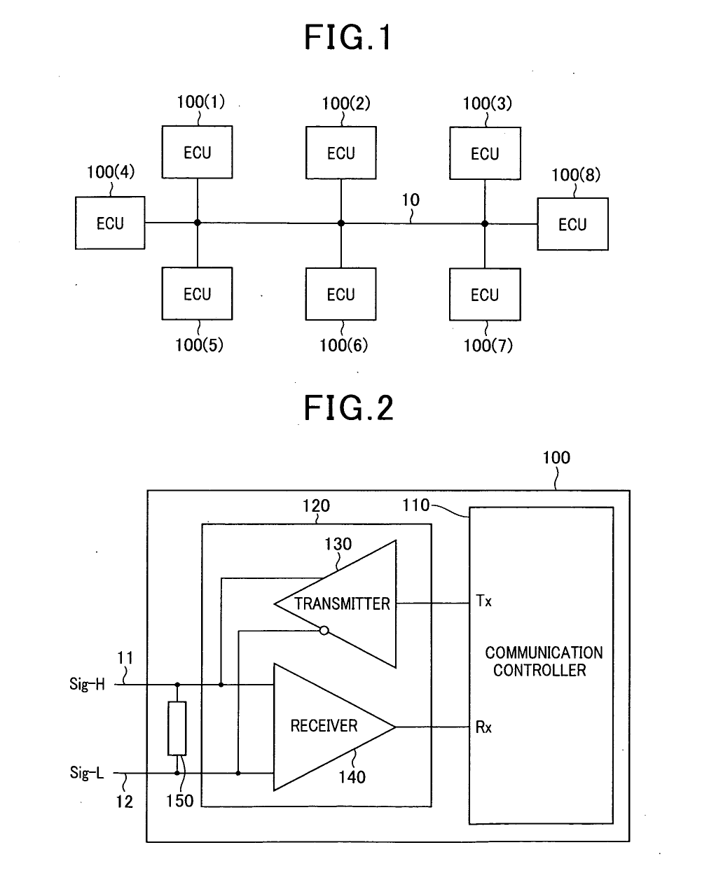

FIG. 1 is a block diagram schematically showing the configuration of the communication system according to the first embodiment.

The communication system is installed in a vehicle. In the communication, a plurality of ECUs (electronic control units) 100(1), 100(2), . . . transmit/receive communication signals (bitwise signals represented by binary form of “dominant/recessive”) to/from each other via a bus 10, which is a common communication line. Hereinafter, the ECU 100(1), 100(2), . . . are generically referred to as “ECU 100”.

In the communication system, each of the ECUs 100 functions as a communication apparatus (node). The communication protocol used between the ECUs 100 is, for example, CAN (Controller Area Network) which is a well-known standard. Specifically, the bus 10 used in the communication system of the first embodiment is a two-wire system consisting of a first communication line (H line) 11 and a second communication line (L line) 12 (refer to FIG. 2 or the like). The “dominant/recessive” property is represented by the difference between the electric potential of the first communication line 11 (hereinafter, referred to as “Sig-H”) and the electric potential of the second communication line 12 (hereinafter, referred to as “Sig-L”). Note that, in the communication system, the bus 10, which is a main line, has a plurality of branch lines, to each of which the ECU 100 is connected (This configuration is a so-called bus-type network).

Note that a relationship between signal logic of a Tx terminal and a Rx terminal of a communication controller 110, described later, and the “dominant/recessive” property, which is a state of a communication signal on the bus 10, is irrelevant to the CAN standard cited as an example of the communication protocol.

(1-2. Configuration of the ECU)

Next, common configurations of the ECUs are described. FIG. 2 is a circuit diagram of the ECU 100.

The ECU 100 includes the communication controller 110 and a transceiver 120. Note that two ECUs 100 (an ECU 100(4) and an ECU 100(8) shown in FIG. 1), the distance between which is longest among distances between any two of the ECUs 100 configuring the communication system, are provided with a terminating resistor 150 connected between the first communication line 11 and the second first communication line 12.

The communication controller 110 is mainly configured by a microcomputer including a CPU, a ROM, and a RAM, and performs processes for communication control. In addition, the communication controller 110 includes the Tx terminal and the Rx terminal, which are communication terminals. The Tx terminal and the Rx terminal are connected to respective communication terminals (which correspond to a transmitter 130 and a receiver 140 described later, respectively).

The transceiver 120 is an IC for an interface between the bus 10 and the communication controller 110, and includes the transmitter (transmitting circuit) 130 and the receiver (receiving circuit) 140. Both the transmitter 130 and the receiver 140 are connected to both the first communication line 11 and the second communication line 12.

The transmitter 130 converts a transmitted signal (hereinafter, referred to as “Tx signal”) outputted from the Tx terminal of the communication controller 110 into a differential signal (communication signal), and transmits the differential signal to the first communication line 11 and the second communication line 12. Specifically, when the Tx signal is in a low level state, the transmitter 130 does not apply a current to the first communication line 11, and does not accept a current from the second communication line 12. Thereby, since a voltage drop does not occur across the terminating resistor 150, the electric potential difference in the differential signal becomes substantially zero, whereby a communication signal representing “recessive” is transmitted. Conversely, when the Tx signal is in a high level state, the transmitter 130 actively applies a current to the first communication line 11, and actively accepts a current from the second communication line 12. Thereby, since a current flows through the terminating resistor 150 and a voltage drop occurs, the electric potential difference in the differential signal is generated, whereby a communication signal representing “dominant” is transmitted. The communication signal generated as described above is transmitted to the receiver 140 of another ECU 100 via the first communication line 11 and the second communication line 12, establishing communication.

In addition, the receiver 140 demodulates (reproduces) the differential signal (communication signal) received from the first communication line 11 and the second communication line 12, and outputs a received signal (hereinafter, referred to as “Rx signal”) to the Rx terminal of the communication controller 110.

(1-3. Configuration of the Transmitter)

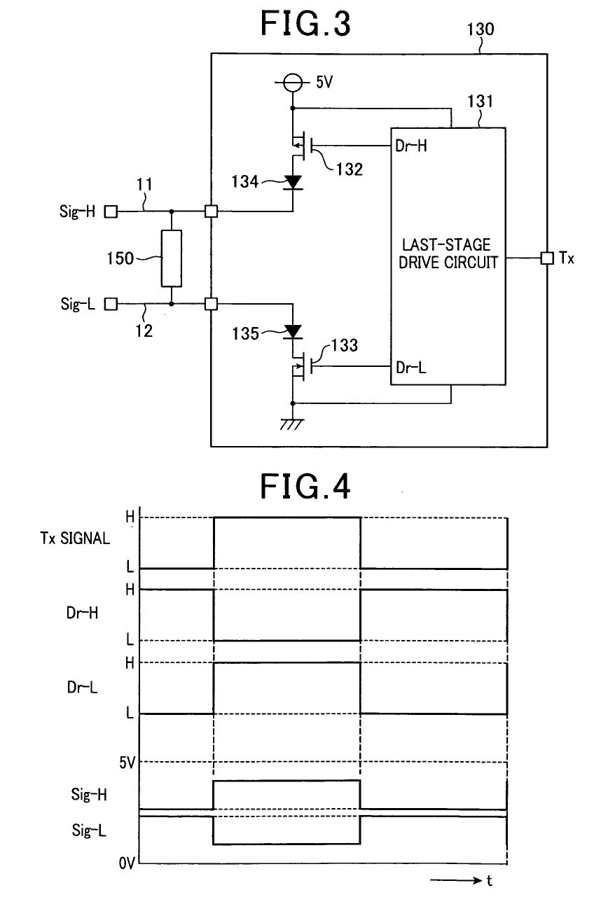

Next, the configuration of the transmitter 130 is described. FIG. 3 is a circuit diagram of the transmitter 130.

The transmitter 130 includes a last-stage drive circuit 131 which receives the Tx signal from the communication controller 110. The last-stage drive circuit 131 has two output terminals Dr-H and Dr-L for outputting a drive signal corresponding to the Tx signal. The output terminal Dr-H is connected to a gate of a transistor 132 (P channel MOSFET) which is connected to the first communication line 11 via a diode 134. The output terminal Dr-L is connected to a gate of a transistor 133 (N channel MOSFET) which is connected to the second communication line 12 via a diode 135.

Specifically, the source of the transistor 132 is connected to a constant-voltage power supply (5V), and the drain of the transistor 132 is connected to the anode of the diode 134. The cathode of the diode 134 is connected to the first communication line 11. The drain of the transistor 133 is connected to the cathode of the diode 135, the source of the transistor 133 is connected to ground (OV). The anode of the diode 135 is connected to the second communication line 12. Note that the diodes 134 and 135 have a function of protecting internal circuits of the transmitter 130 from noise superimposed on the first communication line 11 and the second communication line 12.

Hereinafter, a circuit operation of the transmitter 130 will be described. FIG. 4 is a diagram showing waveforms concerning an operation of the transmitter 130.

The communication controller 110 outputs a low-level (L) Tx signal when transmitting a communication signal representing “recessive” via the bus 10. The communication controller 110 outputs a high-level (H) Tx signal when transmitting a communication signal representing “dominant” via the bus 10.

While the last-stage drive circuit 131 receives a low-level to (recessive) Tx signal from the communication controller 110, the last-stage drive circuit 131 outputs a high-level drive signal from the output terminal Dr-H and outputs a low-level drive signal from the output terminal Dr-L. In this state, both the transistors 132 and 133 become an OFF state. Since no current flows between the first communication line 11 and the second communication line 12 (provided that transmission processes by another ECU 100 are not considered), the electric potential difference therebetween becomes zero (recessive state).

Conversely, while the last-stage drive circuit 131 receives a high-level (dominant) Tx signal from the communication controller 110, the last-stage drive circuit 131 outputs a low-level drive signal from the output terminal Dr-H and outputs a high-level drive signal from the output terminal Dr-L. In this state, both the transistors 132 and 133 become an ON state. Since a current flows from the transistors 132 side to the transistors 133 side via the terminating resistor 150 interposed between the first communication line 11 and the second communication line 12, the electric potential difference is generated across the terminating resistor 150 (dominant state).

As described above, the Tx signal outputted from the communication controller 110 is converted into the differential signal (communication signal) for the first communication line 11 and the second communication line 12 by the transmitter 130.

(1-4. Configuration of the Receiver)

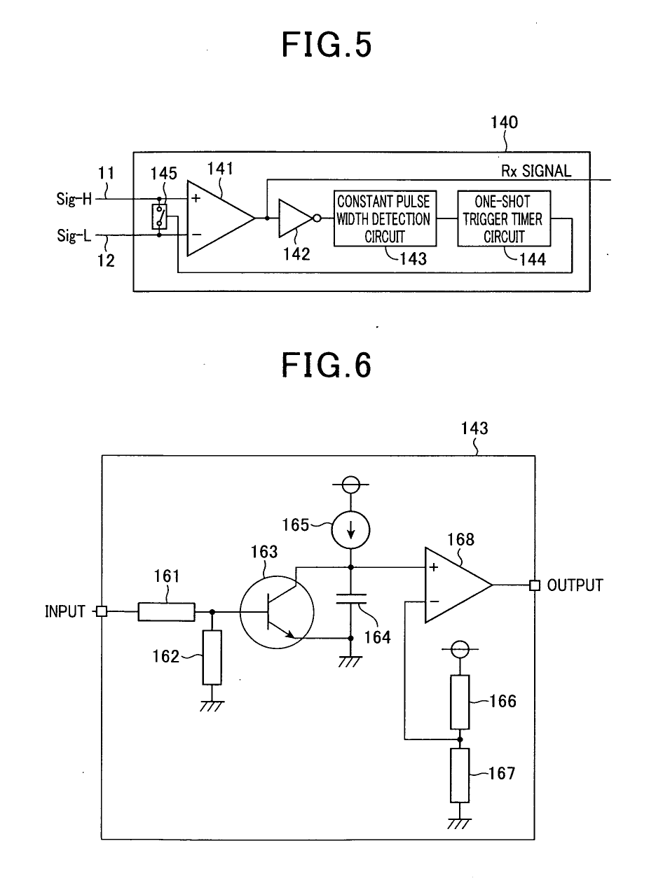

Next, the configuration of the receiver 140 is described. FIG. 5 is a circuit diagram of the receiver 140.

The receiver 140 includes a comparator 141. The comparator 141 receives the electric potential Sig-H of the first communication line 11 through a non-inverting input terminal (positive terminal) thereof, and receives the electric potential Sig-L of the second communication line 12 through an inverting input terminal (positive terminal) thereof. When the difference between the electric potentials is more than a threshold value for demodulating a communication signal, the comparator 141 outputs a high-level signal. When the difference between the electric potentials is equal to or less than the threshold value, the comparator 141 outputs a low-level signal. The output signal of the comparator 141 is inputted to the Rx terminal of the communication controller 110 as the Rx signal. The communication controller 110 determines that the high-level Rx signal is “dominant”, and determines that the low-level received signal is “recessive”.

In addition, the receiver 140 includes an inverter 142, a constant pulse width detection circuit 143, a one-shot trigger timer circuit 144, and an analog switch 145. The inverter 142 logically inverts the signal outputted from the comparator 141. The constant pulse width detection circuit 143 is provided at the subsequent stage of the inverter 142. The one-shot trigger timer circuit 144 is provided at the subsequent stage of the constant pulse width detection circuit 143. The analog switch 145 is connected to the first communication line 11 and the second communication line 12 and is turned on/off by the one-shot trigger timer circuit 144.

The constant pulse width detection circuit 143 outputs a high-level signal when input voltage thereto is kept low level during a period of time T1 which is shorter than the period of time of one bit. Thereafter, the constant pulse width detection circuit 143 changes the output signal to a high-level signal at the timing when the input voltage is changed to high level.

FIG. 6 is a circuit diagram of one example of the constant pulse width detection circuit 143. The constant pulse width detection circuit 143 includes a transistor 163 for switching, a capacitor 164, a constant current source 165, and a comparator 168. A base electric potential (voltage) of the transistor 163 is generated by voltage dividing resistors 161 and 162 which divide input voltage. The capacitor 164 is connected between a collector and an emitter of the transistor 163. The constant current source 165 supplies a constant current to the capacitor 164. A non-inverting input terminal (positive terminal) of the comparator 168 is connected to ground via the capacitor 164. A threshold electric potential (voltage) generated by voltage dividing resistors 166 and 167 is inputted to an inverting input terminal (negative terminal) of the comparator 168.

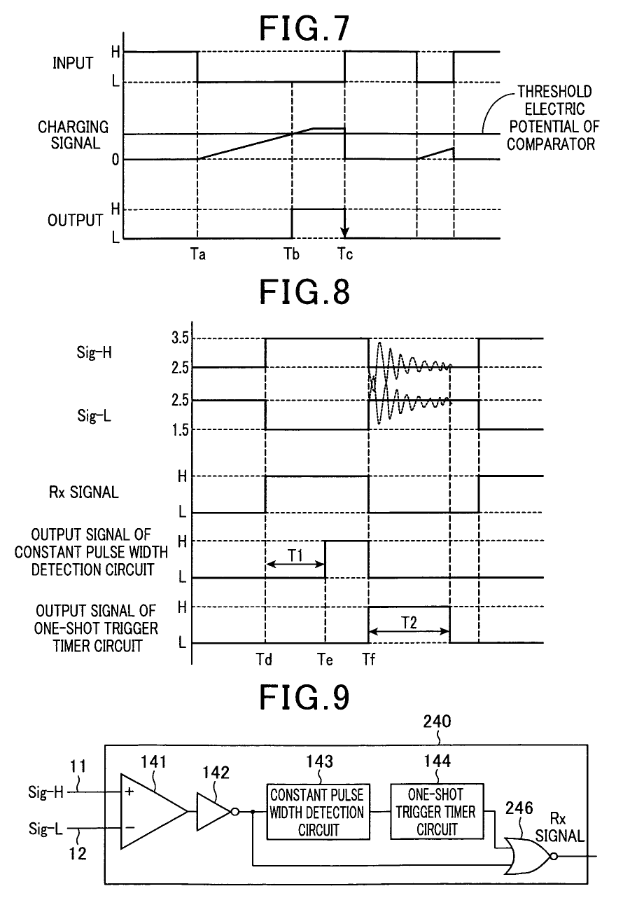

Hereinafter, a circuit operation of the constant pulse width detection circuit 143 will be described. FIG. 7 is a diagram showing waveforms concerning an operation of the constant pulse width detection circuit 143. When the input voltage of the constant pulse width detection circuit 143 is in a high level state (the Rx signal is low level), the transistor 163 is in an ON state, and the electric potential of the non-inverting input terminal (positive terminal) of the comparator 168 is zero.

When the input voltage changes to low level (the Rx signal is high level) (at the timing Ta shown in FIG. 7), the transistor 163 becomes an OFF state, whereby electric charge is accumulated (on charge) in the capacitor 164 at a constant rate by a constant current supplied from the constant current source 165. After a certain period of time, the electric potential inputted to the non-inverting input terminal (positive terminal) of the comparator 168 exceeds the threshold electric potential inputted to the inverting input terminal (negative terminal) (at the timing Tb shown in FIG. 7), whereby the output of the comparator 168 (output voltage of the constant pulse width detection circuit 143) changes from low level to high level. Note that the period of time for charging the capacitor 164 is shorter than that of one bit of a communication signal, and is determined in consideration of one period of noise or a reflected wave superimposed on the bus 10. Specifically, the period of time for charging the capacitor 164 may be set so as to cover a predicted period of time during which a reflected wave would be generated. Alternatively, the period of time for charging the capacitor 164 may be set to be as long as possible but so as to be shorter than the period of time of one bit, regardless of the predicted period of time.

Thereafter, when the input voltage changes to high level (the Rx signal is low level) (at the timing Tc shown in FIG. 7), the transistor 163 becomes an ON state, whereby electric charges accumulated in the capacitor 164 are discharged and the electric potential of the capacitor 164 immediately becomes zero. Thereby, the output from the comparator 168 changes from high level to low level. Note that the change from high level to low level represents a trigger signal for the one-shot trigger timer circuit 144 provided at the subsequent stage

In FIG. 5, the one-shot trigger timer circuit 144 outputs a high-level signal at the timing when the input voltage changes from high level to low level. The high-level signal is outputted during a period of time T2 which is shorter than the period of time of one bit. Note that this type of circuit is generally utilized. For example, LMC 555 (CMOS timer) of National Semiconductor Corporation can be used.

Hereinafter, a circuit operation of the receiver 140 will be described. FIG. 8 is a diagram showing waveforms concerning an operation of the receiver 140.

The differential signal (communication signal) outputted from the transmitter 130 of another ECU 100 to the bus 10 is received by the receiver 140. When the differential signal is in a recessive state, the electric potential difference between the non-inverting input terminal (positive terminal) and the inverting input terminal (negative terminal) of the comparator 141 is equal to or less than the threshold value, whereby the output signal (Rx signal) of the comparator 141 is low level.

When the differential signal changes to “dominant” (at the timing Td shown in FIG. 8), the electric potential difference between the non-inverting input terminal (positive terminal) and the inverting input terminal (negative terminal) of the comparator 141 exceeds the threshold value, whereby the output signal (Rx signal) of the comparator 141 becomes high level. Then, after this state has continued for a period of time T1, the output signal of the constant pulse width detection circuit 143 changes from low level to high level (at the timing Te shown in FIG. 8).

Thereafter, when the differential signal changes to “recessive” (at the timing Tf shown in FIG. 8), the output signal (Rx signal) of the comparator 141 becomes low level, whereby the output signal of the constant pulse width detection circuit 143 changes from high level to low level. Thereby, the output signal of the one-shot trigger timer circuit 144 is kept high level during a period of time T2. During the period of time T2, the analog switch 145 is in an ON state. Thereby, a short circuit is established between the first communication line 11 and the second communication line 12, whereby the impedance becomes substantially zero. Therefore, the output signal (Rx signal) of the comparator 141 is forcefully kept low level (recessive) during the period of time T2.

(Advantages)

As described above, according to the communication system of the first embodiment, the receiver 140 of the ECU 100 determines whether a communication signal received via the bus 10 represents “dominant” or the communication signal represents “recessive”, then outputs an Rx signal indicating the determination result to the communication controller 110. Note that the receiver 140 forcefully outputs the signal indicating “recessive” to the communication controller 110 as the Rx signal, regardless of a communication signal received via the bus 10, during the period of time T2 from the time when the change from “dominant” to “recessive” is detected, based on a communication signal received via the bus 10.

Specifically, when the electric potential difference between the first communication line 11 and the second communication line 12 is more than a threshold value (when the electric potential of the bus 10 meets the condition for determining “dominant”), the comparator 141 outputs a signal indicating “dominant” (high level signal) to the communication controller 110 as the Rx signal. When the electric potential difference between the first communication line 11 and the second communication line 12 is equal to or less than the threshold value (when the electric potential of the bus 10 meets the condition for determining “recessive”), the comparator 141 outputs a signal indicating “recessive” (low level signal) to the communication controller 110 as the Rx signal. In addition, the one-shot trigger timer circuit 144 outputs a high-level signal during the period of time T2 from the time when the change from “dominant” to “recessive” is detected, whereby the analog switch 145 becomes an ON state, establishing a short circuit between the first communication line 11 and the second communication line 12.

According to the communication system of the first embodiment described above, false interpretation of the communication signal due to a reflected wave can be prevented from being caused.

In the communication system, a current is applied to the bus 10 to transmit a communication signal indicating “dominant” via the bus 10, and a current is not applied to the bus 10 to transmit a communication signal indicating “recessive” via the bus 10. In the communication system, a reflected wave causing the false interpretation is generated when the communication signal changes from “dominant” to “recessive”. This is caused by the difference in impedance of the output stage of the transmitter 130. Specifically, the last drive stage of the transmitter 130 becomes high impedance in “recessive” and low impedance in “dominant”. As the difference between the impedance of the bus 10 and the impedance of the transmitter 130 becomes large, the reflected wave becomes large. Thus, a peak value of the reflected wave at the time of the change from “dominant” to “recessive” becomes larger than that at the time of the change from “recessive” to “dominant”.

Therefore, hunting signals (the signals shown by dotted lines in FIG. 8) can be generated on the first communication line 11 and the second communication line 12 due to the reflected wave at the timing when the to differential signal changes from “dominant” to “recessive”. However, during the period of time T2 from the time when the change from “dominant” to “recessive” is detected, a signal indicating “recessive” is outputted to the communication controller 110 as the Rx signal, regardless of a communication signal received via the bus 10. Therefore, the communication signal indicating “recessive” is prevented from being incorrectly determined as a communication signal indicating “dominant” due to the reflected wave.

In addition, in the communication system of the embodiment, when a signal outputted from the comparator 141 is kept “dominant” for equal to or more than the period of time T1 and thereafter changes to “recessive”, the constant pulse width detection circuit 143 activates the one-shot trigger timer circuit 144. Thus, temporary variation in the communication signal due to noise or the like can be prevented from being incorrectly detected as the change from “dominant” to “recessive”.

Note that, in the communication system of the first embodiment, the ECU 100 corresponds to a communication apparatus. The communication controller 110 corresponds to a communication control apparatus. The transceiver 120 corresponds to a communication signal processing apparatus. The transmitter 130 corresponds to a transmitted signal processing means (unit). The receiver 140 corresponds to a received signal processing means (unit). The comparator 141 corresponds to a signal demodulating means (unit). The constant pulse width detection circuit 143 and the one-shot trigger timer circuit 144 correspond to a fixed signal outputting means (unit). The analog switch 145 corresponds to a short-circuiting means (unit). In addition, the period of time T1 corresponds to a stability-detecting period of time. The period of time T2 corresponds to a signal-keeping period of time. The high-level signal outputted from the one-shot trigger timer circuit 144 corresponds to a short-circuit indicating signal.

### 2. Second Embodiment

Next, a communication system according to the second embodiment will be described.

The basic configuration of the communication system of the second embodiment is similar to that of the communication system of the first embodiment. However, each of the ECUs 100 includes a receiver 240 shown in FIG. 9 instead of the receiver 140 shown in FIG. 5. In the second embodiment set forth below, the components identical with or similar to those of the first embodiment are given the same reference numerals for the sake of omitting explanation.

The receiver 240 shown in FIG. 9 differs from the receiver 140 shown in FIG. 5 in that the receiver 240 does not include the analog switch 145 and includes a NOR circuit 246 into which output signals of the inverter 142 and output signals of the one-shot trigger timer circuit 144 are inputted. An output signal of the NOR circuit 246 of the receiver 240 is inputted to the Rx terminal of the communication controller 110 as the Rx signal.

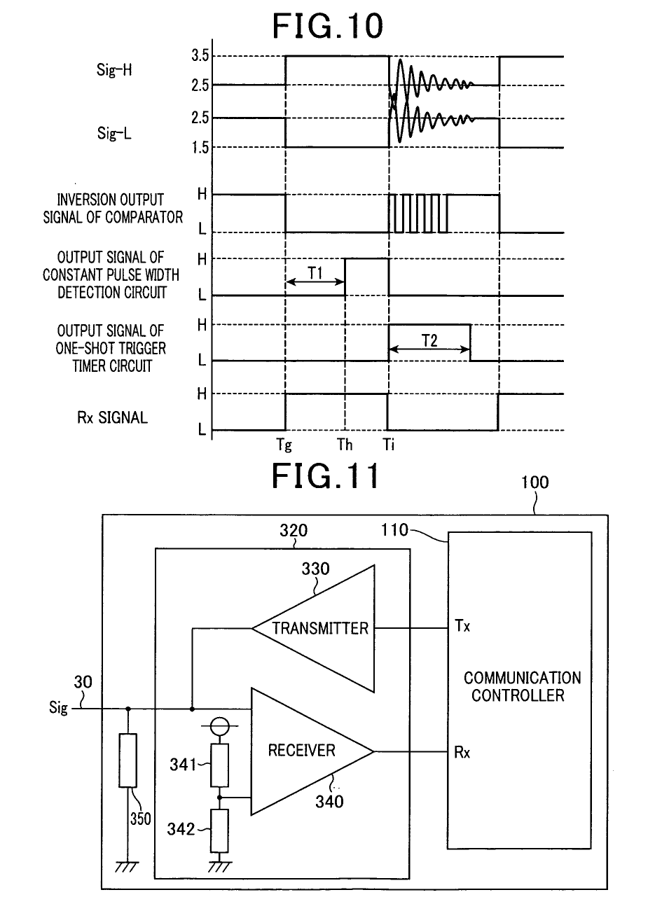

Hereinafter, a circuit operation of the receiver 240 will be described. FIG. 10 is a diagram showing waveforms concerning an operation of the receiver 240.

When the differential signal is in a “recessive” state, the electric potential difference between the non-inverting input terminal (positive terminal) and the inverting input terminal (negative terminal) of the comparator 141 is equal to or less than the threshold value, and an inversion output signal (output signal of the inverter 142) of the comparator 141 is high level.

When the differential signal changes to “dominant” (at the timing Tg shown in FIG. 10), the electric potential difference between the non-inverting input terminal (positive terminal) and the inverting input terminal (negative terminal) of the comparator 141 exceeds the threshold value, whereby an inversion output signal of the comparator 141 becomes low level. Then, after this state has continued for a period to of time T1, the output signal of the constant pulse width detection circuit 143 changes from low level to high level (at the timing Th shown in FIG. 10).

Thereafter, when the differential signal changes to “recessive” (at the timing Ti shown in FIG. 10), an inversion output signal of the comparator 141 becomes high level. However, a hunting signal is generated due to a reflected wave generated when the differential signal changes from “dominant” to “recessive”. Note that an output signal of the constant pulse width detection circuit 143 changes from high level to low level at the timing when an inversion output signal of the comparator 141 changes to high level, then is kept low level. Thereby, an output signal of the one-shot trigger timer circuit 144 is kept high level during a period of time T2. Therefore, during the period of time T2, the hunting signal of the inversion output signal of the comparator 141 is masked so as not to appear as the Rx signal, whereby the Rx signal is kept low level.

As described above, according to the communication system of the second embodiment, when the electric potential difference between the first communication line 11 and the second communication line 12 exceeds a threshold value (when the electric potential of the bus 10 meets the condition for determining “dominant”), the comparator 141 and the inverter 142 output a signal indicating “dominant” (a low-level signal at the input side of the NOR circuit 246). When the electric potential difference between the first communication line 11 and the second communication line 12 is equal to or less than the threshold value (when the electric potential of the bus 10 meets the condition for determining “recessive”), the comparator 141 and the inverter 142 output a signal indicating “recessive” (a high-level signal at the input side of the NOR circuit 246). In addition, the one-shot trigger timer circuit 144 outputs a signal indicating “recessive” (a high-level signal at the input side of the NOR circuit 246) during the period of time T2 from the time when the change from “dominant” to “recessive” is detected, and outputs a signal indicating “dominant” (a low-level signal at the input side of the NOR circuit 246) during another period of time. Then, the NOR circuit 246 receives the signal outputted from the inverter 142 and the signal outputted from the one-shot trigger timer circuit 144. When the signal from the one-shot trigger timer circuit 144 indicates “dominant”, the NOR circuit 246 outputs the signal from the inverter 142 to the communication controller 110 as the Rx signal. When the signal from the one-shot trigger timer circuit 144 indicates “recessive”, the NOR circuit 246 outputs the signal indicating “recessive” to the communication controller 110 as the Rx signal.

The communication system of the second embodiment can obtain the same advantages as those of the communication system of the first embodiment.

Note that, in the communication system of the second embodiment, the ECU 100 corresponds to a communication apparatus. The communication controller 110 corresponds to a communication control apparatus. The transceiver 120 corresponds to a communication signal processing apparatus. The transmitter 130 corresponds to a transmitted signal processing means (unit). The receiver 240 corresponds to a received signal processing means (unit). In addition, the comparator 141 and the inverter 142 correspond to a signal demodulating means (unit). The constant pulse width detection circuit 143 and the one-shot trigger timer circuit 144 correspond to a fixed signal outputting means (unit). The NOR circuit 246 corresponds to a signal selection means (unit). In addition, the period of time T1 corresponds to a stability-detecting period of time. The period of time T2 corresponds to a signal-keeping period of time.

### 3. Third Embodiment

Next, a communication system according to the third embodiment will be described.

The basic configuration of the communication system of the third embodiment is similar to that of the communication system of the first embodiment. However, a bus 30 which is a single-wire communication line is used instead of the two-wire communication line. According to the difference, each of the ECUs 100 configuring the communication system of the third embodiment includes a transceiver 320 shown in FIG. 11 instead of the transceiver 120 shown in FIG. 2. In the third embodiment set forth below, the components identical with or similar to those of the first embodiment are given the same reference numerals for the sake of omitting explanation.

The transceiver 320 includes a transmitter 330 and a receiver 340 which are connected to the bus 30. The bus 30 is connected to ground (0V) via a terminating resistor 350.

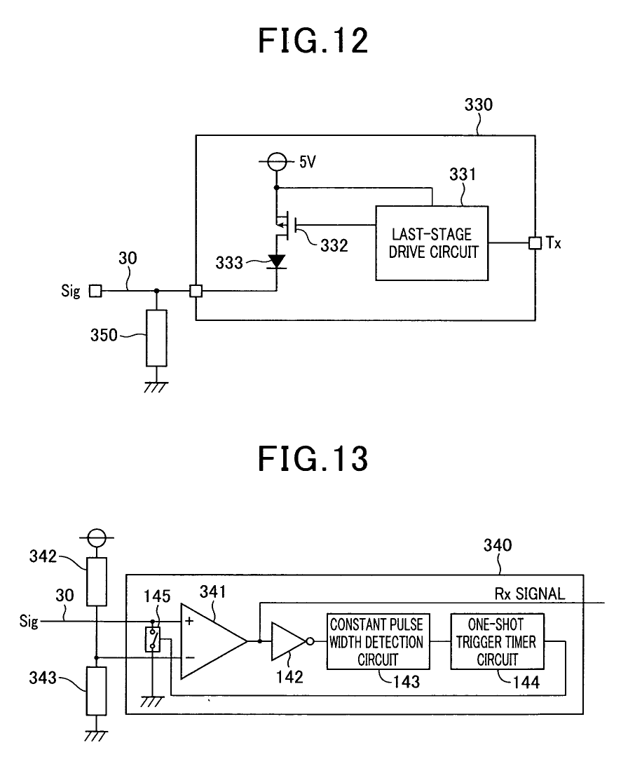

Next, the configuration of the transmitter 330 is described. FIG. 12 is a circuit diagram of the transmitter 330.

The transmitter 330 includes a last-stage drive circuit 331 which receives the Tx signal from the communication controller 110. The last-stage drive circuit 331 is connected to a gate of a transistor 332 (P channel MOSFET) which is connected to the bus 30 via a diode 333. A source of the transistor 332 is connected to a constant-voltage power supply (5V), and a drain of the transistor 332 is connected to an anode of the diode 333. A cathode of the diode 333 is connected to the bus 30. Note that the diode 333 has a function of protecting internal circuits of the transmitter 330 from noise superimposed on the bus 30.

Next, the configuration of the receiver 340 is described. FIG. 13 is a circuit diagram of the receiver 340.

The receiver 340 differs from the receiver 140 of the first embodiment in that the analog switch 145 of the receiver 340 is connected between the bus 30 and ground, and the receiver 340 includes a comparator 341 shown in FIG. 13 instead of the comparator 141 shown in FIG. 5. Other configurations of the receiver 340 are common with to those of the receiver 140.

In the comparator 341, the electric potential Sig of the bus 30 is inputted to a non-inverting input terminal (positive terminal), and a threshold electric potential for demodulating a communication signal generated by voltage dividing resistors 342 and 343 is inputted to an inverting input terminal (negative terminal). When the electric potential Sig of the bus 30 is equal to or less than the threshold electric potential, the comparator 341 outputs a low-level signal. When the electric potential Sig of the bus 30 exceeds the threshold electric potential, the comparator 341 outputs a high-level signal.

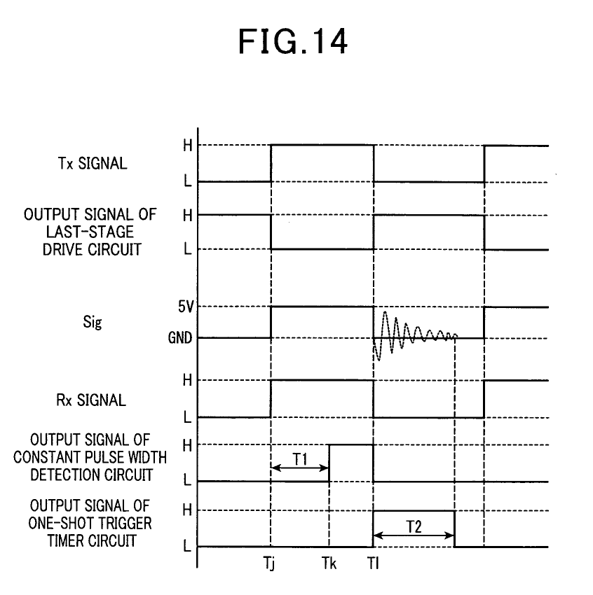

Hereinafter, circuit operations of the transmitter 330 and the receiver 340 will be described. FIG. 14 is a diagram showing waveforms concerning operations of the transmitter 330 and the receiver 340.

When transmitting a signal indicating “recessive”, the communication controller 110 outputs a low-level (L) Tx signal. When transmitting a signal indicating “dominant”, the communication controller 110 outputs a high-level (H) Tx signal.

In the transmitter 330, while the last-stage drive circuit 331 receives the low-level (recessive) Tx signal from the communication controller 110, the last-stage drive circuit 331 outputs a high-level drive signal from an output terminal. In this state, the transistor 332 becomes an OFF state, and the electric potential Sig of the bus 30 becomes zero (provided that transmission processes by another ECU 100 are not considered) (recessive state).

Meanwhile, while the last-stage drive circuit 331 receives the high-level (dominant) Tx signal from the communication controller 110, the last-stage drive circuit 331 outputs a low-level drive signal from an output terminal. In this state, the transistor 332 becomes an ON state, and the electric potential Sig of the bus 30 becomes closer to 5 V (dominant state) than to 0v (recessive state) with respect to 2.5 V (i.e. more than 2.5V). Note that the electric potential Sig of the bus 30 in the dominant state is obtained by subtracting the forward voltage of the diode 333 from 5V, and dividing the resultant voltage with resistance of the terminating resistor 350 and ON resistance of the transistor 332.

As described above, the Tx signal outputted from the communication controller 110 is converted into the electric potential Sig of the bus 30 by the transmitter 330.

Meanwhile, in the receiver 340, the output signal (Rx signal) of the comparator 341 is low level in the state where the electric potential Sig of the bus 30 is in a recessive state (0V).

When the electric potential Sig of the bus 30 changes to dominant (5V) (at the timing Tj shown in FIG. 14), the output signal (Rx signal) of the comparator 341 becomes high level. After this state has continued for the period of time T1, the output signal of the constant pulse width detection circuit 143 changes from low level to high level (at the timing Tk shown in FIG. 14).

Thereafter, when the electric potential Sig of the bus 30 changes to “recessive” (0V) (at the timing TI shown in FIG. 14), the output signal (Rx signal) of the comparator 341 becomes low level, whereby the output signal of the constant pulse width detection circuit 143 changes from high level to low level. Thereby, the output signal of the one-shot trigger timer circuit 144 is kept high level during the period of time T2. During the period of time T2, the analog switch 145 is in an ON state. Thereby, a short circuit is established between the bus 30 and ground, whereby the electric potential Sig becomes substantially zero. Therefore, the output signal (Rx signal) of the comparator 141 is forcefully kept low level during the period of time T2.

As described above, according to the communication system of the third embodiment, when the electric potential of the bus 30 is more than the threshold value (when the electric potential of the bus 30 meets the condition for determining “dominant”), the comparator 341 outputs a signal indicating “dominant” (high-level signal) to the communication to controller 110 as the Rx signal. When the electric potential of the bus 30 is equal to or less than the threshold value (when the electric potential of the bus 10 meets the condition for determining “recessive”), the comparator 341 outputs a signal indicating “recessive” (low-level signal) to the communication controller 110 as the Rx signal. In addition, the one-shot trigger timer circuit 144 outputs a high-level signal during the period of time T2 from the time when the change from “dominant” to “recessive” is detected, whereby the analog switch 145 becomes an ON state, establishing a short circuit between the bus 30 and ground.

The communication system of the third embodiment can obtain the same advantages as those of the communication system of the first embodiment.

Note that, in the communication system of the third embodiment, the ECU 100 corresponds to a communication apparatus. The communication controller 110 corresponds to a communication control apparatus. The transceiver 320 corresponds to a communication signal processing apparatus. The transmitter 330 corresponds to a transmitted signal processing means (unit). The receiver 340 corresponds to a received signal processing means (unit). In addition, the comparator 341 corresponds to a signal demodulating means (unit). The constant pulse width detection circuit 143 and the one-shot trigger timer circuit 144 correspond to a fixed signal outputting means (unit). The analog switch 145 corresponds to a short-circuiting means (unit). In addition, the period of time T1 corresponds to a stability-detecting period of time. The period of time T2 corresponds to a signal-keeping period of time. The high level signal outputted from the one-shot trigger timer circuit 144 corresponds to a short-circuit indicating signal.

### 4. Other Embodiments

It will be appreciated that the present invention is not limited to the configurations described above, but any and all modifications, variations or equivalents, which may occur to those who are skilled in the art, should be considered to fall within the scope of the present invention.

In the communication system of the third embodiment, the configuration of the communication system of the first embodiment is applied to single-wire communication. Similarly, the configuration of the communication system of the second embodiment can also be applied to single-wire communication.

In the communication systems of the above embodiments, the Rx signal is forcefully fixed as a signal indicating “recessive” during the period of time T2 only at the time of the change from “dominant” to “recessive”. Additionally, the Rx signal may be forcefully fixed as a signal indicating “dominant” during the period of time T2 at the time of the change from “recessive” to “dominant”. This can prevent the communication signal from being incorrectly determined due to a reflected wave generated at the time of the change from “recessive” to “dominant”.

In the above embodiments, the communication systems including the constant pulse width detection circuit 143 are exemplified. However, a communication system which does not include the constant pulse width detection circuit 143 can be configured.

The above embodiments exemplify the communication systems for a vehicle. However, the communication systems may be applied for other uses.

Hereinafter, aspects of the above-described embodiments will be summarized.

As an aspect of the embodiment, the communication signal processing apparatus is included in one of a plurality of communication apparatuses configuring a communication system in which the communication apparatuses transmit/receive a communication signal to/from each other via a common communication line, and functions as an interface between the communication line and a communication control apparatus which is included in the communication apparatus and performs a process for controlling communication. The communication signal processing apparatus includes a transmitted signal processing unit and a received signal processing unit.

The transmitted signal processing unit, in accordance with a transmitted signal outputted from the communication control apparatus, transmits a communication signal indicating “dominant” via the communication line by applying a current to the communication line, and transmits a communication signal indicating “recessive” via the communication line by not applying a current to the communication line. Note that the wording “applying a current to the communication line” includes a meaning of “accepting a current from the communication line”.

Meanwhile, the received signal processing unit determines whether the communication signal received via the communication line indicates “dominant” or the communication signal indicates “recessive”, then outputs a received signal indicating the determination result to the communication control apparatus. The received signal processing unit outputs a signal indicating “recessive” to the communication control apparatus as the received signal, regardless of the communication signal received via the communication line, during a predetermined signal-keeping period of time from the time when detecting a change from “dominant” to “recessive” based on the communication signal received via the communication line.

According to the above communication signal processing apparatus, a communication signal can be prevented from being incorrectly determined due to a reflected wave. The reflected wave causing the incorrect determination is generated when the communication signal changes from “dominant” to “recessive” in the communication system in which a current is applied to the communication line to transmit the communication signal indicating “dominant” via the communication line and a current is not applied to the communication line to transmit the communication signal indicating “recessive” via the communication line. In the communication signal processing apparatus of the embodiment, the signal indicating “recessive” is outputted to the communication control apparatus as the received signal, regardless of the communication signal received via the communication line, during the signal-keeping period of time from the time when the change from “dominant” to “recessive” is detected. Therefore, the communication signal indicating “recessive” is prevented from being incorrectly determined as “dominant” due to the reflected wave generated when the communication signal changes from “dominant” to “recessive”.

In the above communication signal processing apparatus, the communication line is a two-wire system including a first communication line and a second communication line. The received signal processing unit includes a signal demodulating unit, a fixed signal outputting unit, and a short-circuiting unit.

The signal demodulating unit outputs a signal indicating “dominant” to the communication control apparatus as the received signal when the electric potential difference between the first communication line and the second communication line is more than a predetermined threshold value, and outputs a signal indicating “recessive” to the communication control apparatus as the received signal when the electric potential difference is equal to or less than the threshold value. The fixed signal outputting unit outputs a short-circuit indicating signal during the signal-keeping period of time from the time when a change from “dominant” to “recessive” is detected based on the signal outputted from the signal demodulating unit, the short-circuit indicating signal being different from a signal outputted during a period of time other than the signal-keeping period of time. The short-circuit unit establishes a short circuit between two input lines for inputting electric potentials of the first communication line and the second communication line to the signal demodulating unit while the fixed signal outputting unit outputs the short-circuit indicating signal.

According to the above communication signal processing apparatus, due to a simple configuration in which the two input lines are short-circuited, the signal indicating “recessive” is outputted to the communication control apparatus as the received signal during the signal-keeping period of time from the time when the change from “dominant” to “recessive” is detected.

In addition, in the above communication signal processing apparatus, the received signal processing unit includes a signal demodulating unit, a fixed signal outputting unit, and a signal selection unit.

The signal demodulating unit outputs a signal indicating “dominant” when an electric potential of the communication line meets a condition for determining “dominant”, and outputs a signal indicating “recessive” when the electric potential meets a condition for determining “recessive”. The fixed signal outputting unit outputs a signal indicating “recessive” during the signal-keeping period of time from the time when a change from “dominant” to “recessive” is detected based on the signal outputted from the signal demodulating unit, and outputs a signal indicating “dominant” during a period of time other than the signal-keeping period of time. The signal selection unit receives the signal outputted from the signal demodulating unit and the signal outputted from the fixed signal outputting unit, outputs the signal outputted from the signal demodulating unit to the communication control apparatus as the received signal when the signal outputted from the fixed signal outputting unit indicates “dominant”, and outputs a signal indicating “recessive” outputted from the fixed signal outputting unit as the received signal when the signal outputted from the fixed signal outputting unit indicates “recessive”.

According to the above communication signal processing apparatus, due to a simple configuration in which the signal outputted from the signal demodulating unit and the signal outputted from the fixed signal outputting unit are selectively outputted as the received signal, the signal indicating “recessive” is outputted to the communication control apparatus as the received signal during the signal-keeping period of time from the time when the change from “dominant” to “recessive” is detected.

In addition, in the above communication signal processing apparatus, the communication line is a single-wire system. The received signal processing unit includes a signal demodulating unit, a fixed signal outputting unit, and a short-circuiting unit.

The signal demodulating unit outputs a signal indicating “dominant” to the communication control apparatus as the received signal when the electric potential of the communication line is more than a predetermined threshold value, and outputs a signal indicating “recessive” to the communication control apparatus as the received signal when the electric potential is equal to or less than the threshold value. The fixed signal outputting unit outputs a short-circuit indicating signal during the signal-keeping period of time from the time when a change from “dominant” to “recessive” is detected based on the signal outputted from the signal demodulating unit, the short-circuit indicating signal being different from a signal outputted during a period of time other than the signal-keeping period of time. The short-circuit unit short-circuits an input line, which inputs an electric potential of the communication line to the signal demodulating unit, to a recessive electric potential while the fixed signal outputting unit outputs the short-circuit indicating signal.

According to the above communication signal processing apparatus, due to a simple configuration in which the input line is short-circuited to a recessive electric potential, the signal indicating “recessive” is outputted to the communication control apparatus as the received signal during the signal-keeping period of time from the time to when the change from “dominant” to “recessive” is detected.

Due to factors such as a configuration of the communication system and the environment thereof, a communication signal temporarily varies due to noise and the like generated on the communication line. The temporary variation can be incorrectly detected as the change from “dominant” to “recessive”.

In the communication signal processing apparatus, when the signal outputted from the signal demodulating unit is kept “dominant” for equal to or more than a predetermined stability-detecting period of time and thereafter changes to “recessive”, the fixed signal outputting unit detects the change as a change from “dominant” to “recessive”.

According to the above communication signal processing apparatus, the temporary variation in a communication signal due to noise and the like can be prevented from being incorrectly detected as the change from “dominant” to “recessive”.

The communication apparatus of the embodiment includes any one of the above communication signal processing apparatuses.

What is claimed is:

1. A communication signal processing apparatus which is included in one of a plurality of communication apparatuses configuring a communication system in which the communication apparatuses transmit/receive a communication signal to/from each other via a common communication line, and which functions as an interface between the communication line and a communication control apparatus which is included in the communication apparatus and performs a process for controlling communication, comprising:
a transmitted signal processing unit which, in accordance with a transmitted signal outputted from the communication control apparatus, transmits a communication signal indicating “dominant” via the communication line by applying a current to the communication line, and transmits a communication signal indicating “recessive” via the communication line by not applying a current to the communication line; and
a received signal processing unit which determines whether the communication signal received via the communication line indicates “dominant” or the communication signal indicates “recessive”, then outputs a received signal indicating the determination result to the communication control apparatus, wherein
the received signal processing unit outputs a signal indicating “recessive” to the communication control apparatus as the received signal, regardless of the communication signal received via the communication line, during a predetermined signal-keeping period of time from the time when detecting a change from “dominant” to “recessive” based on the communication signal received via the communication line.

2. The communication signal processing apparatus according to claim 1, wherein
the communication line is a two-wire system including a first communication line and a second communication line, and
the received signal processing unit includes:
a signal demodulating unit which outputs a signal indicating “dominant” to the communication control apparatus as the received signal when the electric potential difference between the first communication line and the second communication line is more than a predetermined threshold value, and outputs a signal indicating “recessive” to the communication control apparatus as the received signal when the electric potential difference is equal to or less than the threshold value;
a fixed signal outputting unit which outputs a short-circuit indicating signal during the signal-keeping period of time from the time when a change from “dominant” to “recessive” is detected based on the signal outputted from the signal demodulating unit, the short-circuit indicating signal being different from a signal outputted during a period of time other than the signal-keeping period of time; and
a short-circuiting unit which establishes a short circuit between two input lines for inputting electric potentials of the first communication line and the second communication line to the signal demodulating unit while the fixed signal outputting unit outputs the short-circuit indicating signal.

3. The communication signal processing apparatus according to claim 1, wherein
the received signal processing unit includes:
a signal demodulating unit which outputs a signal indicating “dominant” when an electric potential of the communication line meets a condition for determining “dominant”, and outputs a signal indicating “recessive” when the electric potential meets a condition for determining “recessive”;
a fixed signal outputting unit which outputs a signal indicating “recessive” during the signal-keeping period of time from the time when a change from “dominant” to “recessive” is detected based on the signal outputted from the signal demodulating unit, and outputs a signal indicating “dominant” during a period of time other than the signal-keeping period of time; and
a signal selection unit which receives the signal outputted from the signal demodulating unit and the signal outputted from the fixed signal outputting unit, outputs the signal outputted from the signal to demodulating unit to the communication control apparatus as the received signal when the signal outputted from the fixed signal outputting unit indicates “dominant”, and outputs a signal indicating “recessive” outputted from the fixed signal outputting unit as the received signal when the signal outputted from the fixed signal outputting unit indicates “recess i ve”.

4. The communication signal processing apparatus according to claim 1, wherein
the communication line is a single-wire system, and
the received signal processing unit includes:
a signal demodulating unit which outputs a signal indicating “dominant” to the communication control apparatus as the received signal when the electric potential of the communication line is more than a predetermined threshold value, and outputs a signal indicating “recessive” to the communication control apparatus as the received signal when the electric potential is equal to or less than the threshold value;
a fixed signal outputting unit which outputs a short-circuit indicating signal during the signal-keeping period of time from the time when a change from “dominant” to “recessive” is detected based on the signal outputted from the signal demodulating unit, the short-circuit indicating signal being different from a signal outputted during a period of time other than the signal-keeping period of time; and
a short-circuiting unit which short-circuits an input line, which inputs an electric potential of the communication line to the signal demodulating unit, to a recessive electric potential while the fixed signal outputting unit outputs the short-circuit indicating signal.

5. The communication signal processing apparatus according to claim 2, wherein
when the signal outputted from the signal demodulating unit is kept “dominant” for equal to or more than a predetermined stability-detecting period of time and thereafter changes to “recessive”,
the fixed signal outputting unit detects the change as a change from “dominant” to “recessive”.

6. The communication signal processing apparatus according to claim 3, wherein
when the signal outputted from the signal demodulating unit is kept “dominant” for equal to or more than a predetermined stability-detecting period of time and thereafter changes to “recessive”,
the fixed signal outputting unit detects the change as a change from “dominant” to “recessive”.

7. The communication signal processing apparatus according to claim 4, wherein
when the signal outputted from the signal demodulating unit is kept “dominant” for equal to or more than a predetermined stability-detecting period of time and thereafter changes to “recessive”,
the fixed signal outputting unit detects the change as a change from “dominant” to “recessive”.

8. A communication apparatus which includes the communication signal processing apparatus according to claim 1.
